(19) United States
(12) Patent Application Publication
(10) Pub. No.: US 2017/0118580 A1
(43) Pub. Date: Apr. 27, 2017

(54) PROCESSING APPARATUS, VEHICULAR SYSTEM AND METHOD FOR PROCESSING AUDIO DATA

(71) Applicant: LEAUTO INTELLIGENT TECHNOLOGY (BEIJING) CO.LTD, Beijing (CN)

(72) Inventor: Peng TIAN, Beijing (CN)

(21) Appl. No.: 14/972,050

(22) Filed: Dec. 16, 2015

(30) Foreign Application Priority Data
Oct. 21, 2015 (CN) 201510689403.6

(51) Int. Cl. H04W 4/00; H04W 76/02; H04W 72/04; H04L 29/08

(52) U.S. Cl. CPC H04W 4/008; H04L 67/12; H04W 76/023; H04W 72/0453

(57) ABSTRACT

The present disclosure is related to an apparatus applied in a vehicular system, a vehicular system and a method for processing the audio data. The processing apparatus includes a first connection control module configured to establish a wireless connection with an electronic device, to obtain an audio data of the electronic device through the wireless connection, to obtain a current reception band of a FM playback device in the vehicular system, and to generate a first transmission command according to the current reception band; and a FM transmitter module configured to respond to the first transmission command of the control module, and to transmit the audio data at the current reception band. The present disclosure achieves the interaction with electronic devices, increases the utilization of the vehicular system in the vehicles and improves the user experience.

### CROSS-REFERENCE TO RELATED APPLICATION

This application claims priority under 35 U.S.C. §119(a) to Patent Application No(s). 201510689403.6, filed in China on Oct. 21, 2015, the entire contents of which is hereby incorporated by reference.

### FIELD OF TECHNOLOGY

The present disclosure is related to the field of vehicle technology, and more particular to a processing apparatus in a vehicular system, a vehicular system and a method for processing the audio data.

### BACKGROUND

With the continuous development and progress of science and technology, the vehicle system applied in the car, easy for the user to travel, capable of bring the convenient operation to the user and bringing more user experience begins to appear in the vehicle.

Currently, most of the vehicle system mainly provides vehicle navigation providing the satellite positioning and the electronic map function. However, with the increase of user's need, especially the popularity of smart phones and other electronic devices, the information exchanged between the vehicular system and the electronic devices required in order to achieve portability operation has become the main demands of users. Functions of existing vehicle systems are relatively simple and the performance needs to be improved.

### SUMMARY

The present disclosure provides a processing apparatus applied in a vehicular system, a vehicular system and a method for processing the audio data to solve the technical problem that functions of vehicular systems are relatively simple.

One embodiment of the present disclosure provides a processing apparatus applied in a vehicular system. The apparatus includes:

a first connection control module configured to establish a wireless connection with an electronic device, to obtain an audio data of the electronic device through the wireless connection, to obtain a current reception band of a FM (frequency modulation) playback device in the vehicular system, and to generate a first transmission command according to the current reception band; and

a FM (frequency modulation) transmitter module configured to respond to the first transmission command of the control module, and to transmit the audio data at the current reception band.

One embodiment of the present disclosure provides a processing apparatus applied in a vehicular system. The apparatus includes:

a memory;

one or more program instruction modules, stored in the memory;

one or more processors, couple to the memory to execute one or more program instruction modules to:

establish a wireless connection with an electronic device;

obtain an audio data of the electronic device through the wireless connection;

obtain a current reception band of a FM playback device in the vehicular system;

generate a first transmission command according to the current reception band;

respond to the first transmission command of the control module; and

transmit the audio data at the current reception band.

One embodiment of the present disclosure provides a vehicular system comprising the foregoing processing apparatus and the FM playback device.

One embodiment of the present disclosure provides a method for processing the audio data applied in a vehicular system. The method includes:

obtaining an audio data of the electronic device through the wireless connection after establishing a wireless connection with an electronic device;

obtaining a current reception band of a FM playback device in the vehicular system; generating a first transmission command according to the current reception band;

responding to the first transmission command of the control module, and transmitting the audio data at the current reception band.

One embodiment of the present disclosure provides a method for processing the audio data applied in an electronic device. The method includes:

establishing a wireless connection with a processing apparatus of the vehicular system;

transmitting an audio data to the process apparatus through the wireless connection; obtaining a current reception band of a FM playback device in the vehicular system after the processing apparatus receives the audio data; generating a first transmission command according to the current reception band; responding to the first transmission command of the control module; and transmitting the audio data at the current reception band.

The present disclosure provides a processing apparatus applied in a vehicular system, a vehicular system and a method for processing the audio data. The processing apparatus can establish the wireless connection with an electronic device and obtain the audio data of the electronic device through the wireless connection. The processing apparatus generates the audio data in the current reception band according to the current obtained reception band of a FM playback device in the vehicular system. Therefore, the FM playback device can receive the audio data and autoplay in the current reception band. The interaction with electronic devices is achieved and functions of the vehicular system is enriched. The present disclosure achieves the interaction with electronic devices, increases the utilization of the vehicular system in the vehicles, is convenient for user operations and improves the user experience.

### BRIEF DESCRIPTION OF THE DRAWINGS

In order to illustrate the technical schemes of the prior art or the embodiments of the present disclosure more clearly, the accompanying drawings for illustrating the prior art or the embodiments of the present disclosure are briefly described as below. It is apparent that the drawings described below are merely some embodiments of the present disclosure, and those skilled in the art may derive other drawings according the drawings described below without creative endeavor. In the drawings:

FIG. 1 is a schematic diagram of the apparatus applied in a vehicular system according to one embodiment of the present disclosure;

FIG. 2 is the schematic diagram of the apparatus applied in a vehicular system according to another embodiment of the present disclosure;

FIG. 3A is the schematic diagram of the apparatus applied in a vehicular system according to another embodiment of the present disclosure;

FIG. 3B is the schematic diagram of the apparatus applied in a vehicular system according to another embodiment of the present disclosure;

FIG. 4 is a schematic diagram of the vehicular system according to one embodiment of the present disclosure;

FIG. 5 is the schematic diagram of the vehicular system according to another embodiment of the present disclosure;

FIG. 6 is a flow chart of the method for processing the audio data according to one embodiment of the present disclosure;

FIG. 7 is the flow chart of the method for processing the audio data according to another embodiment of the present disclosure; and

FIG. 8 is the flow chart of the method for processing the audio data according to another embodiment of the present disclosure.

### DESCRIPTION OF THE EMBODIMENTS

For the purpose, technical solution, and advantage of the present disclosure becoming clearer, the specific embodiments of the present disclosure combined with the accompanying drawings to clearly and completely are described as follows. Obviously, the described embodiments are only part of the embodiments of the present disclosure rather than all embodiments. Based on the embodiments of the present disclosure all other embodiments obtained by those having ordinary skills in this field without creative work are within the scope of protection of the present disclosure.

The technical solution of the present disclosure is mainly applied in the vehicle. With the popularity of mobile phones, tablet and other electronic devices, the electronic device becomes a user carry-on item. In order to ensure driving safety and take full advantages of electronic devices in the process during the user driving the vehicle, it is a main research trend to increase the driving experiences and improve the convenience for the operations. Therefore, requests of the vehicle from users are more and more increasing, in particular to the interaction between the vehicular system and the electronic devices.

In order to increase the utilization of the vehicular system and improve the user experience, the present disclosure provides a processing apparatus applied in a vehicular system. The processing apparatus includes a first connection control module and a FM transmitter module. The first connection control module is configured to establish a wireless connection with an electronic device. The electronic device can transmit the audio data to the first connection control module. When the first connection control module obtains the audio data, the first connection control module obtains a current reception band of a FM playback device in the vehicular system and generates a first transmission command according to the current reception band. The FM transmitter module is configured to respond to the first transmission command of the control module, and to transmit the audio data at the current reception band. The audio data can be automatically played through the FM playback device in the vehicular system. Therefore, the convenience of user operations is improved and the utilization of the vehicular system in the vehicles is also increased.

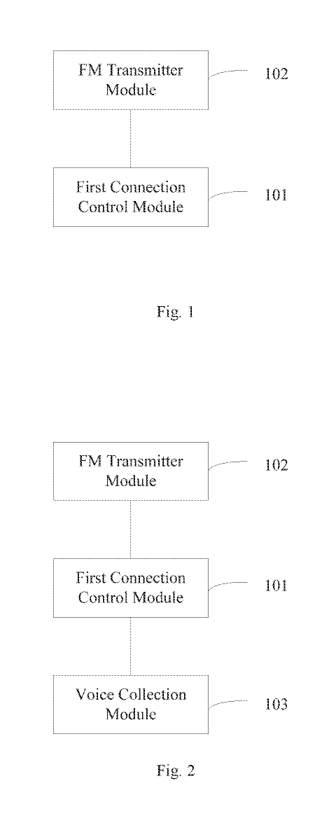

FIG. 1 is a schematic diagram of the apparatus applied in a vehicular system according to one embodiment of the present disclosure. The processing apparatus includes a first connection control module 101 and a FM transmitter module 102.

The first connection control module 101 is configured to establish a wireless connection with an electronic device, to obtain an audio data of the electronic device through the wireless connection, to obtain a current reception band of a FM playback device in the vehicular system, and to generate a first transmission command according to the current reception band.

The FM transmitter module 102 is configured to respond to the first transmission command of the control module, and to transmit the audio data at the current reception band.

The processing apparatus of the embodiment of the present disclosure is disposed in the vehicle and belongs to the vehicular system. The processing apparatus can establish wireless connections with electronic devices. The processing apparatus includes the FM transmitter module and broadcasts the audio data through the FM transmitter module. The audio data in the electronic device is transmitted to the processing apparatus through the wireless connection. The processing apparatus can generate the audio data according to the current reception band of a FM playback device in the vehicular system. The processing apparatus is close to the FM playback device and has large transmission power. Therefore, the FM playback device can receive the audio data transmitted from the processing apparatus and broadcast it. The FM playback device can autoplay the audio data without modulating the frequency by the user.

The audio data of the electronic device can be the audio data stored in the electronic device, the audio data obtained through the network connection or the audio data obtained through the communication connection, i.e. voice communication data.

In practical applications, it is difficult to operate the electronic devices when driving a vehicle, especially the electronic devices receive a call request of the voice communication. On the other hand, users usually want to listen to music when driving the vehicle in order to increase the entertainment experience of driving. Radio programs broadcasted by the FM playback device in the prior art only can be passively received without target or achieved by inserting the memory disc with burdensome operation.

In order to take full advantage of electronic devices and increase the utilization of the vehicular system, it is more convenient to operate by interactive implementation of the electronic devices and the vehicular system. The inventors have proposed the technical solutions of the present disclosure after a series of studies. In one embodiment of the present disclosure, the audio data in the electronic device can be transmitted through the FM transmitter module of the processing apparatus and played on the FM playback device in the vehicular system. The embodiment of the present disclosure as the processing apparatus in the vehicular system can play the audio data in the electronic device to increase the utilization of the vehicular system. The processing apparatus transmits the audio data in the current reception band of the FM playback device. The FM playback device can automatically play the audio data in the electronic device without manual operation. The operation is simple and the user experience is improved.

The wireless connection established between the first connection control module and the electronic device may be a short-distance wireless connection. Bluetooth technology as sophisticated short-range wireless communications technology, has been widely applied to the short-distance data exchange between fixed devices and mobile devices. It can connect to multiple devices and solve the problem of data synchronization, so that the connection between the first connection control module and the electronic device may be a specific Bluetooth connection.

The first connection control module may be implemented by adopting the hardware, i.e. Microcontroller Unit (MCU). The MCU can be a Bluetooth chip, for example CSR8670 chip.

The first connection control module may be composed of the Bluetooth module and the microcontroller to achieve the wireless connection and process operations of the transmission data in the wireless connection. The FM playback device can specifically be the FM radio and other devices in the vehicular system

In one embodiment, the first connection control module 101 obtaining an audio data of the electronic device through the wireless connection, obtaining a current reception band of a FM playback device in the vehicular system, and generating a first transmission command according to the current reception band, may include:

obtaining the transmitted audio data of the electronic device through the wireless connection;

obtaining the current reception band of the FM playback device in the vehicular system;

determining whether the current reception band is the same as a default band;

generating the first transmission command according to the current reception band when the current reception band is not the same as the default band; and

generating a second transmission command according to the current reception band when the current reception band is the same as the default band;

wherein the FM transmitter module 102 is further configured to respond to the second transmission command, and transmit the audio data in the default band.

The FM transmitter module responds to the first transmission command and transmits the audio data in the current reception band when receiving the first transmission command. The FM transmitter module responds to the second transmission command and transmits the audio data in the default band when receiving the second transmission command.

In one embodiment, the processing apparatus can set the default band. The default band can be uncommonly used or idle band in the preset FM band. The default band can be set in the processing apparatus during the factory-setting stage.

Therefore, the audio data can be transmitted in the default band if the current reception band of the FM playback device is not the same as the default band.

The audio data can be transmitted in the current reception band if the current reception band is not the same as the default band. The FM playback device can automatically play the audio data without users' manual operations. The playback efficiency of the audio data is improved and the playback immediacy is ensured.

In another embodiment, the first connection control module 101 obtaining the transmitted audio data of the electronic device through the wireless connection, obtaining the current reception band of the FM playback device in the vehicular system, and generating the first transmission command according to the current reception band, may include:

obtaining the transmitted audio data of the electronic device through the wireless connection;

determining whether the transmitted band of the electronic device is received;

obtaining the current reception band of the FM playback device in the vehicular system when the transmitted band of the electronic device is not received; generating the first transmission command according to the current reception band;

generating a third transmission command according to the transmitted band when the transmitted band of the electronic device is received; and

the FM transmitter module 102 further responds to the third transmission command, and transmits the audio data at the transmitted band.

The FM transmitter module responds to the first transmission command and transmits the audio data in the current reception band when receiving the first transmission command. The FM transmitter module responds to the third transmission command and transmits the audio data in the transmitted band when receiving the third transmission command.

In one embodiment, if the processing apparatus further receives the transmitted band transmitted from the electronic device, i.e. the transmitted band of the electronic device preset the audio data, the electronic device specifically searches an idle band and chooses the idle band to be the transmission band of the audio data. Users set the current reception band to be the transmission band in the electronic device according to a current reception band of the FM playback device. The electronic device monitors the current reception band of the FM playback device and sets the current reception band for the transmission band.

The processing apparatus transmits the audio data according to the transmission bands. The FM playback device can receive the audio data by turning to the transmission bands at this time.

In order to achieve the autoplayback of the audio data, the first connection control module determines whether the current reception band is the same as a transmission band. If the current reception band of the FM playback device is the same as the transmission band, it generates the audio data according to the transmission band. If the current reception band of the FM playback device is not the same as the transmission band, it generates the audio data according to the current reception band.

In another embodiment, the first connection control module 101 obtaining the transmitted audio data of the electronic device through the wireless connection, obtaining the current reception band of the FM playback device in the vehicular system, and generating the first transmission command according to the current reception band, may include:

obtaining the transmitted audio data of the electronic device through the wireless connection;

determining whether the idle band exists;

obtaining the current reception band of the FM playback device in the vehicular system when the idle band exists;

generating a forth transmission command according to the idle band when an idle band exists; and

the FM transmitter module 102 further responds to the forth transmission command, and transmits the audio data at the idle band.

In one embodiment, the processing apparatus can automatically search the band and choose the idle band to transmit the audio data. The processing apparatus transmits the idle band to the electronic device and triggers the electronic device to output in order to remind users turning the band of the FM playback device to the idle band.

In the practical applications, the transmitted audio data of the electronic device may be embodied as a voice communication data. Therefore, as a further embodiment:

the first connection control module 101 is configured to receive a call request of the electronic device, and control the electronic device to establish a voice communication channel when receiving an answering instruction;

wherein the first connection control module 101 obtains the transmitted audio data of the electronic device through the wireless connection, comprising:

obtaining the transmitted audio data received from the voice communication channel of the electronic device through the wireless connection. That is the voice communication data. The FM playback device in the vehicular system listening to the voice communication data through the processing apparatus is achieved.

The answering instruction can be triggered by users. Different control bottoms can be disposed on the processing apparatus. The processing apparatus can be triggered to generate different control commands through the different control bottoms by users, wherein the answering instruction can be a control command generated by triggering the incoming call control button.

When the first connection control module 101 establishes a Bluetooth connection with the electronic devices, controlling the incoming call of the electronic devices may be achieved based on the Hands-free Profile (HFP) protocol. The Hands-free Profile (HFP) protocol determines that the incoming call can be controlled by Bluetooth devices, i.e. answering, hanging up, rejecting, voice dialing and other functions.

Therefore, the embodiments of the processing apparatus can receive the call request to the electronic device, and control the electronic device to establish a voice communication channel.

The processing apparatus also can control the electronic device to end the call request when receiving the instruction of hanging up the call.

In order to enable the information exchange, as a further embodiment shown in FIG. 2, the differences between the current embodiment and the embodiment shown in FIG. 1 are that the processing apparatus may further include:

a voice collection module 103 configured to collect the environmental voice; and

the first connection control module 101 is further configured to transmit the environmental voice to the electronic device through the wireless connection.

In a voice communications scenario, the electronic device receives the audio data through the voice communication channel. The first connection control module 101 obtains the audio data received by the electronic device through the wireless connection. After the first connection control module transmitting the environmental voice to the electronic device through the wireless connection, the first connection control module can trigger the electronic device transmitting the environmental voice to the voice communication channel.

The environmental voice includes the user voice. Therefore, the processing apparatus can achieve the voice communication in the vehicular system. The processing apparatus not only receives the voice communication data through the vehicular system, but also transmits the environmental voice to the electronic device to trigger the electronic device transmitting the environmental voice through the voice communication channel to achieve the voice communication.

Users' voices are the main source of the environmental voice. The first connection control module 101 further reduces the noise in the environmental voice because the environmental voice also includes users' voices. The users' voices in the environmental voice is jammed by the voice broadcasted from the FM playback device. Therefore, the voice broadcasted from the FM playback device in the environmental voice can be removed to obtain the users' voices with low noise.

In other application scenario, for example, in the application of the voice recognition, the environmental voice is recognized for voice recognition by the electronic apparatus after receiving the environmental voice. The voice command is recognized and responds to the operation corresponding to the voice command. For example, opens some application in the electronic device or initiates a call.

In another embodiment, the noise reduction of the environmental voice can achieved through the voice processing module connected to the first connection control module. The voice processing module connects to the voice collection module and first connection control module respectively and is specifically configured to reduces the noise in the environmental voice collected by the voice collection module. The voice processing module in practical applications can be a voice processing chip, for example, the voice processing chip CX20921.

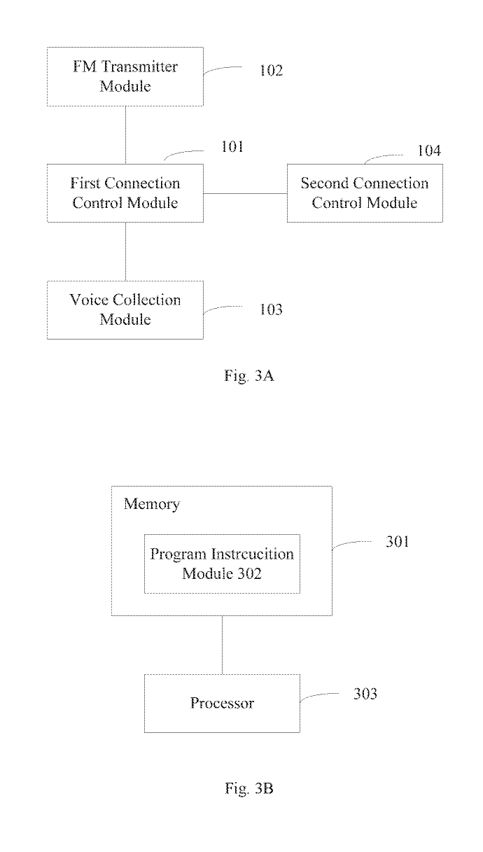

In order to increase the utilization of the vehicular system and enrich functions of the vehicular system, in another embodiment, as shown in FIG. 3A, the differences between the current embodiment and the embodiment shown in FIG. 2 are that the processing apparatus may further include:

a second connection control module 104 configured to establish wireless connections with a plurality of detecting devices in the vehicles, and transmit the vehicle information detected by the plurality of detecting devices to the electronic device through the first connection control module.

The plurality of detecting devices detects different vehicle information, for example, temperature, humidity, pressure, etc. The vehicle information is transmitted to the electronic device through the processing apparatus for user viewing and processing.

The detecting devices for detecting the vehicle can be set to any number of devices. The vehicle may need more detecting devices with increasing requirements of the vehicle safety and the driving performance.

Therefore, the second connection control module can be configured to establish ZigBee connections with each detecting devices. The second connection control module can be a MCU with the ZigBee function, for example, the ZigBee integrated circuit, CC2530 chip etc.

The ZigBee technology can be expanded easily. The second connection control module can connect up to 65535 nodes, thereupon facilitating the expansion of detecting device.

The plurality of detecting devices includes sensors in different type. Following are several possible sensors:

Thermal sensors that may add touch button function in control buttons of the processing apparatus and achieve the functions like sliding back and forth for changing songs, sliding up and down/rotating left and right to control volume;

Pressure sensors that may detect the tire pressure;

Temperature sensors that may detect the temperature inside or outside of the vehicle;

Vibration sensors that may detect whether the vehicle vibration is normally;

Three-axis sensor that may detect the acceleration and/or angle of the vehicle;

Humidity sensor that may detect the environmental humidity;

Illumination sensor that may configure to LED light in vehicle for automatic brightness adjustment; and

Air sensor that may detect the air quality in the vehicle.

The first connection control module of the processing apparatus further connects to LED light in the interior of the vehicle and adjusts the brightness of the LED light according to the illumination information from the illumination sensor.

The first connection control module further connects to the air condition of the vehicle and adjusts the interior temperature or humidity according to the humidity sensor or the temperature sensor.

Furthermore, the GPS module is further disposed in the processing apparatus and connects to the first connection control module for collecting the vehicle traveling data. The first connection control module transmits the traveling data to the electronic device.

The processing apparatus further includes the detecting devices connected to the first connection control module. For example, the acceleration sensor. By way of combination with the acceleration and the angular velocity algorithm, it may obtain the vehicle's current posture, a sudden acceleration, a sudden deceleration, sharp turns, collisions and other states in real time. The first connection control module transmits the data detected by the acceleration sensor to the electronic device.

It may be seen from the above description that the processing apparatus can be configured with the control buttons to generate different control instructions according to the control buttons operated by users, transmit the control instructions to the electronic device to achieve the electronic device controls. For example, establishing a voice communication tunnel by answering the phone or ending the voice communication tunnel; selecting the previous or the next song, fast forwards or rewinds, or adjusting the sound volume when playing the audio data on the electronic device.

In order to facilitate the operation of the processing apparatus, in the embodiment of the present disclosure, the first connection control module of the processing apparatus may establish connections with the control devices disposed in a steering wheel. The control devices are configured with a plurality of control buttons. The users operate the control buttons to generate control commands to send to the processing apparatus.

The processing apparatus obtains the control commands transmitted from the control devices, transmits control commands to the electronic device and trigger the electronic device to respond to control commands to perform corresponding operations.

The connections between the control apparatus and the first connection control module can be a Bluetooth connection. The control commands can be transmitted through the Bluetooth connection. The control commands of the control devices can be generated when receiving control requests from users.

Controls of the electronic devices also can be achieved through the control commands of the control devices. Different control commands can be achieved through triggering the control buttons of the control devices. When the control buttons are touching buttons, different touch operations can be achieved through executing the control buttons of the control devices, for example, click, double click, press, etc. After the processing apparatus receiving the control commands, the control commands are transmitted to the electronic devices. The electronic devices responds to the control commands, therefore achieving the switching of the audio data, adjusting sound volume, stopping or restarting the playback of the audio data, or answering the incoming call to establish a voice communication channel or end the voice communication channel etc.

In addition, the processing apparatus includes at least two operating modes, which are the sleeping mode and the working mode.

The processing apparatus is in sleeping mode when the first connection control module does not connect to any electronic devices or the vehicle in the stall state.

The processing apparatus switches from the sleeping mode to the working mode. One possible manner to achieve is that the processing apparatus switches from the sleeping mode to the working mode when the first connection control module connects to any electronic devices. Another possible manner to achieve is that the processing apparatus switches from the sleeping mode to the working mode when the processing apparatus receives a waking command. The waking command can be achieved through the control device. The waking command is generated by the corresponding control button through the user triggering and transmitted to the processing apparatus. The processing apparatus is triggered to switch from the sleeping mode to the working mode. Another possible manner to achieve is that the processing apparatus switches from the sleeping mode to the working mode when the processing apparatus is powered. For example, the supply voltage is detected to become non-zero.

The power management module is disposed in the processing apparatus and connected to each module. The power management module includes a power supply port. The power supply port is connected to the power supply equipment in the vehicle and powered to supply the electric power to the processing apparatus. The power supply port is specifically a Micro USB port.

The power supply module can further be disposed in the processing apparatus and connected to the power management module. The power supply module includes a USB port. The USB port can be connected to the electronic device, supply the voltage source to the electronic device and charge the electronic device.

Furthermore, the first connection control module can obtain the vehicle information according to the temperature sensor of the plurality of detecting devices. The first connection control module can trigger the power management module to stop supplying the electric power and disconnect with the power supply equipment when the interior temperature is higher than a default value.

The first connection control module can further output a notice message after establishing a wireless connection with the electronic device. The first connection control module also can transmit the notice message to the electronic device. The electronic device outputs the notice message to prompt the user the successful connection of the electronic device.

In another embodiment, a plurality of indicators connecting to the first connection control module can further be disposed in the processing apparatus. Different indicators turned on or off represent different situations of the devices. After the electronic device establishes the wireless connection successfully, the indicator representing the connection situation is lighted up and represents that the device connection is successful.

When the first connection control module receives the call request from the electronic device, the indicator of the incoming call can be lighted up to prompt the user that the call request from the electronic device.

When the first connection control module is a bluetooth processing chip and not connected to the electronic device, it may send a broadcast signal (ibeacon frames). When the electronic device is apart from a certain distance from the vehicle, it may receive the broadcast signal, thereby establishing a bluetooth connection with the first connecting control module.

As a still another embodiment, the processing apparatus further includes a storage module, for at least storing the vehicle state information detected by the plurality of detecting devices.

The storage module may be a flash.

After the first connecting control device is connected to the electronic device, the first connecting control device further synchronously transmits the vehicle information stored by the storage device to the electronic device.

In the embodiment of the present disclosure, the connecting control module in the processing device may support different operating systems, such as Android and IOS system. The processing device may be provided with an over-the-air technology (OTA) interface, so as to upgrade the operating system of the connecting control module.

When the first connecting control module is the bluetooth processing module, it may support a variety of bluetooth protocols, such as HFP, advanced audio distribution profile (A2DP), audio/video remote control profile (AVRCP), serial port profile (SPP), so as to achieve the transmission and the control of the data through the bluetooth.

In another embodiment of the present disclosure, the processing apparatus outputs the corresponding notice message when detecting the wireless connection with the electronic device or receiving the call request from the electronic device.

The notice message is a predetermined audio data and transmitted from the processing apparatus through the FM transmission module and played by the FM playback device.

For example, by the frequency modulation transmitting module and when the connection may also be established by the first connection control module and the electronic device, the FM transmitting module is triggered to transmit a first predetermined audio data in the predetermined frequency band, and the first predetermined audio data may be “device connection successful” and may be played by the FM playback device to prompt the user.

When disconnecting with the electronic device, the frequency modulation transmitting module may be triggered to transmit a second predetermined audio data in the predetermined frequency band, and the second predetermined audio data may be “device has been disconnected” and may be played by the FM playback device to prompt the user.

When the first connection control module receives the call request or the short message request, the FM transmitting module may also be triggered to emit a third predetermined audio data in the default frequency band, and the third predetermined audio data may be “new call or new message.”

As a possible implement manner, the processing apparatus or control device may also be provided with a plurality of indicators.

The different notice messages may be indicated by lighting up in the different colors of indicators in the electronic device or the control device. The different notice messages may also be indicated by lighting up or off the different indicators in the electronic device or the control device.

For example, after establishing the wireless connection with the electronic device, the indicator indicating the connection state may be lighted up or the indicator may be changed to green, so as to indicate the device connection successful; if the indicator indicating the connection state changes to red, it may indicate the connection failure.

When the second connection control module receives the call request of the electronic device, the call indicator may be lighted up or the indicator may be changed to green, so as to indicate the call request of the electronic device to the user.

Additionally, in one embodiment of the present disclosure, the processing apparatus may further cooperate with a display module connected to the first connecting control. The display module is used to display the positioning information of the electronic map and the GPS module. The call number and the contact in the call request of the electronic device is displayed.

FIG. 3B is a schematic diagram of the apparatus applied in a vehicular system according to one embodiment of the present disclosure. The processing apparatus includes:

a memory 301;

a program instruction module 302 stored in the memory; and

a processor 303 couples to the memory to execute the program instruction module to:
establish a wireless connection with an electronic device;
obtain an audio data of the electronic device through the wireless connection;
obtain a current reception band of a FM playback device in the vehicular system;
generate a first transmission command according to the current reception band;
respond to the first transmission command of the control module; and

transmit the audio data at the current reception band.

Memory 301 may include read only memory (ROM), flash memory and/or random access memory (RAM) and is configured to store the program instruction module executed by the processor 303. The program instruction module 302 comprise routines, program, object, component or Web Service and so on. The processor 303 may include a single central-processing unit (CPU) or a plurality of parallel processing unit of parallel processing environment. The amount of could program instruction module 302 or processor 303 may be one or more than one.

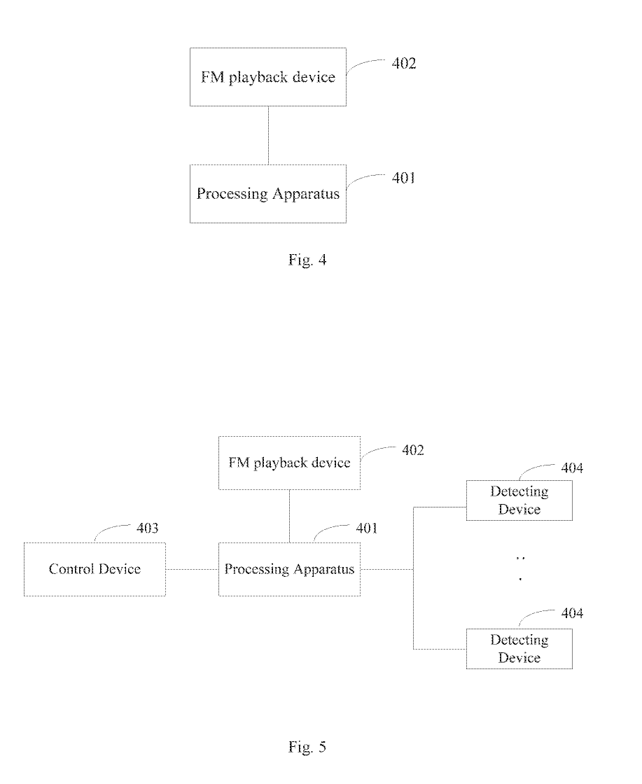

A vehicular system is also provided in the present disclosure, as shown in FIG. 4, a diagram schematic of the vehicular system according to one embodiment of the present disclosure. The vehicular system includes: the processing apparatus 401 and the FM playback device 402.

The specific embodiments of the processing apparatus 401 can be found in the foregoing description. The processing apparatus 401 may establish the wireless connection with an electronic device, obtain the audio data of the electronic device through the wireless connection, obtain the current reception band of the FM playback device in the vehicular system, generate the first transmission command according to the current reception band, and transmit the audio data in the current reception band responding to the first transmission command of the control module.

The FM playback device can receive and play the audio data in the current reception band.

In another embodiment, as shown in FIG. 5, the vehicular system further includes control devices 403 connected to the processing apparatus 401; and a plurality of detecting devices 404 connected to the processing apparatus.

The plurality of detecting devices can be disposed at different positions in the vehicle, comprising interior of the vehicle, tire, front of the vehicle etc.

The vehicular system of the embodiment of the present disclosure can not only achieve the vehicular navigation but also establish connection with the electronic device. The interaction with the electronic devices and playing the audio data in the electronic device are achieved, and functions of the vehicular system is enriched. The present disclosure increases the utilization of the vehicular system in the vehicles and improves the user experience.

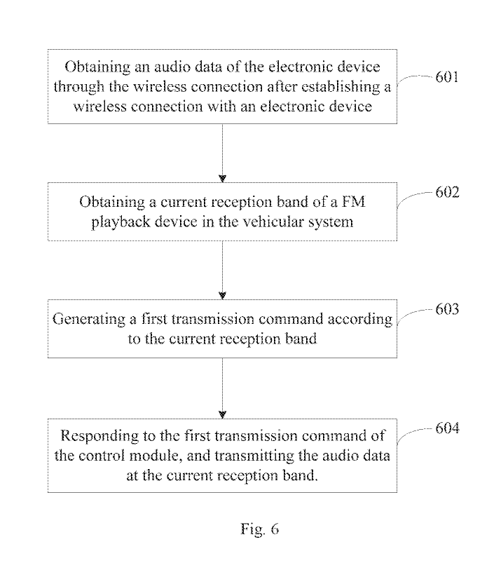

FIG. 6 is a flow chart of the method for processing the audio data according to one embodiment of the present disclosure. The embodiment is specifically applied in the vehicular system. The specific embodiments of the vehicular system can be found in the foregoing description. The method may include the following steps:

Step 601: obtaining an audio data of the electronic device through the wireless connection after establishing a wireless connection with an electronic device;

Step 602: obtaining a current reception band of a FM playback device in the vehicular system;

Step 603: generating a first transmission command according to the current reception band; and

Step 604: responding to the first transmission command of the control module, and transmitting the audio data at the current reception band.

The audio data of the electronic device can be the audio data stored at local of the electronic device, the audio data obtained through the network connection or the audio data obtained through the communication connection, i.e. voice communication data.

In the embodiment of the present disclosure, the audio data in the electronic device is transmitted in the current reception band of the FM playback device. Therefore, the FM playback device can transmit the audio data in the current reception band and automatically play the audio data in the electronic device without manual operation. The present disclosure increases the convenience of using the electronic device and improves the user experience.

In one embodiment, the wireless connection with the electronic device is a Bluetooth connection.

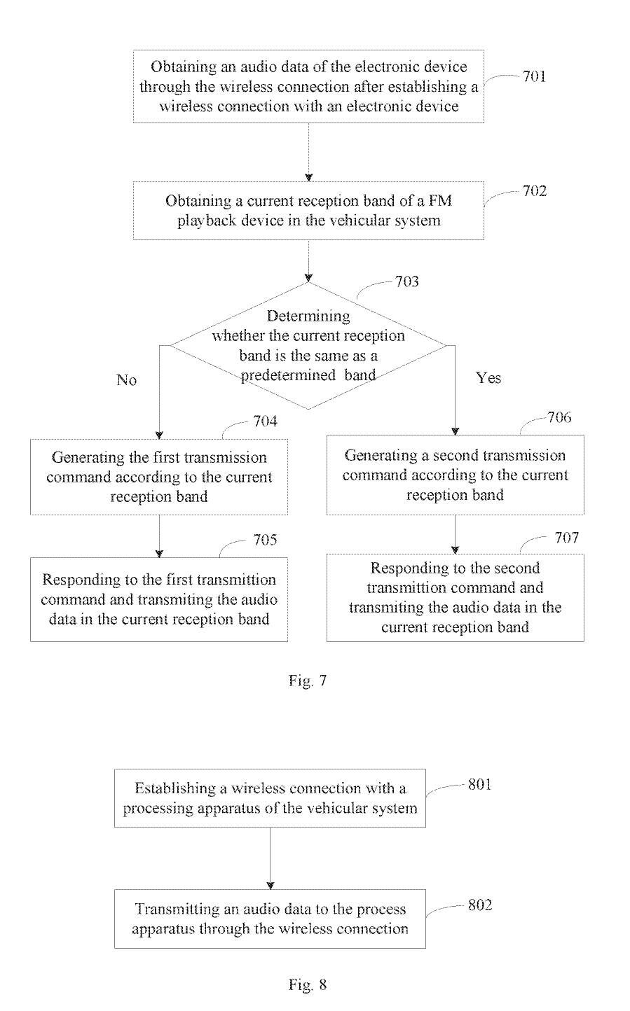

FIG. 7 is the flow chart of the method for processing the audio data according to another embodiment of the present disclosure. The embodiment is specifically applied in the vehicular system. The specific embodiments of the vehicular system can be found in the foregoing description. The method may include the following steps:

Step 701: obtaining an audio data of the electronic device through the wireless connection after establishing a wireless connection with an electronic device;

Step 702: obtaining a current reception hand of a FM playback device in the vehicular system;

Step 703: determining whether the current reception band is the same as a default band. If the current reception band is not the same as the default band, goes to Step 704. If the current reception band is the same as the default band, goes to Step 706;

Step 704: generating the first transmission command according to the current reception band;

Step 705: responding to the first transmission command and transmitting the audio data in the current reception band;

Step 706: generating a second transmission command according to the current reception band; and

Step 707: responding to the second transmission command and transmitting the audio data in the current reception band.

In one embodiment, the audio data can be transmitted in the default band if the current reception band of the FM playback device is not the same as the default band. The audio data can be transmitted in the current reception band if the current reception band is not the same as the default band. Therefore, the FM playback device can autoplay the audio data without users' manual operations. The playback efficiency of the audio data is improved and the playback immediacy is ensured.

In another embodiment, after obtaining the transmitted audio data of the electronic device through the wireless connection, the step determines whether the transmitted band of the electronic device is received.

The step obtains the current reception band of the FM playback device in the vehicular system when the transmitted band of the electronic device is not received; the step generates the first transmission command according to the current reception band.

Generates a third transmission command according to the transmitted band, when the transmitted band of the electronic device is received. The step responds to the third transmission command, and transmits the audio data at the transmitted band.

In another embodiment, after obtaining the transmitted audio data of the electronic device through the wireless connection, the step determines whether the idle band is existed. The step obtains the current reception hand of the FM playback device in the vehicular system when there is no idle band existed; the step generates the first transmission command according to the current reception band.

Generates a forth transmission command according to the idle band when there is an idle band existed. The step responds to the forth transmission command, and transmits the audio data at the idle band.

Further, the step transmits the idle band to the electronic device so as to the electronic device outputs in order to remind users turning the band of the FM playback device to the idle band.

In the practical applications, the transmitted audio data of the electronic device may be embodied as a voice communication data. Therefore, as a further embodiment:

obtaining the transmitted audio data of the electronic device through the wireless connection after establishing the wireless connection with the electronic device, comprising:

receiving a call request of the electronic device after establishing the wireless connection with the electronic device;

controlling the electronic device to establish a voice communication channel when receiving an answering instruction; and

obtaining the transmitted audio data received from the voice communication channel of the electronic device through the wireless connection.

Now, after transmitting the audio data, the method further includes:

collecting the environmental voice; and

transmitting the environmental voice to the electronic device through the wireless connection and the electronic device triggered to transmit the environmental voice to the voice communication channel. Therefore, the vehicular system achieves the voice communication.

FIG. 8 is the flow chart of the method for processing the audio data according to another embodiment of the present disclosure. The embodiment is specifically applied in the vehicular system. The method may include the following steps:

Step 801: establishing a wireless connection with a processing apparatus of the vehicular system; and

Step 802: transmitting an audio data to the process apparatus through the wireless connection; obtaining a current reception band of a FM playback device in the vehicular system after the processing apparatus receives the audio data; generating a first transmission command according to the current reception band; responding to the first transmission command of the control module; and transmitting the audio data at the current reception band.

In one embodiment, the step of establishing a wireless connection with a processing apparatus of the vehicular system further includes:

receiving a broadcast signal transmitted from the processing apparatus of the vehicular system; and

establishing a wireless connection with the processing apparatus of the vehicular system when the strength of the broadcast signal is higher than the predetermined strength.

According to the embodiment of the present disclosure, the interaction between the vehicular system and the electronic devices is achieved. The audio data of the electronic device is automatically played on the FM playback device in the vehicular system. The method transmits the data to the electronic device, comprising the environmental voice and the detected vehicle information etc. Functions of the vehicular system are enriched. The electronic device is fully used. The disclosure may increase the convenience of using the electronic device and the utilization of the vehicular system in the vehicles.

The above description of embodiments, those skilled in the art can clearly understand the various embodiments may be implemented by software plus a necessary universal hardware platform for implementation, and of course, also be implemented by hardware. Based on this understanding, the nature of the technical proposal or the part contributing to the prior art may be embodied in the form of a software product. The computer software product may be stored in a computer readable storage medium, such as ROM/RAM, magnetic disc, CD-ROM, including several instructions to instruct a computer device (a personal computer, a server, or a network equipment) to perform the method described in some parts of the various embodiments or examples.

Finally, it should be noted that the above embodiments are merely provided for describing the technical solutions of the present disclosure, but not intended to limit the present disclosure. Although reference to the embodiments of the present disclosure has been described in details, those skilled in the art will appreciate that the technical solutions described in the foregoing embodiments can be modified, or equivalently replaced for some technical features; and such modifications or replacements do not make the essence of the corresponding technical solutions depart from the spirit and scope of the technical implementation of the present disclosure.

1. An apparatus applied in a vehicular system, comprising:
a first connection control module configured to establish a wireless connection with an electronic device, to obtain an audio data of the electronic device through the wireless connection, to obtain a current reception band of a FM playback device in the vehicular system, and to generate a first transmission command according to the current reception band; and
a FM transmitter module configured to respond to the first transmission command of the control module, and to transmit the audio data at the current reception band.

2. The apparatus of claim 1, wherein the first connection control module obtains the transmitted audio data of the electronic device through the wireless connection, obtains the current reception band of the FM playback device in the vehicular system, generates the first transmission command according to the current reception band, comprises:
obtaining the transmitted audio data of the electronic device through the wireless connection;
obtaining the current reception band of the FM playback device in the vehicular system;
determining whether the current reception band is the same as a default band;
generating the first transmission command according to the current reception band when the current reception band is not the same as the default band;
generating a second transmission command according to the current reception band when the current reception band is the same as the default band; and
wherein the FM transmitter module is further configured to respond to the second transmission command, and transmit the audio data in the default band.

3. The apparatus of claim 1, wherein the first connection control module obtains the transmitted audio data of the electronic device through the wireless connection, obtains the current reception band of the FM playback device in the vehicular system, and generates the first transmission command according to the current reception band, comprises:
obtaining the transmitted audio data of the electronic device through the wireless connection;
determining whether the transmitted band of the electronic device is received; obtaining the current reception band of the FM playback device in the vehicular system
when the transmitted band of the electronic device is not received; generating the first transmission command according to the current reception band;
generating a third transmission command according to the transmitted band when the transmitted band of the electronic device is received; and
the FM transmitter module further responds to the third transmission command, and transmits the audio data at the transmitted band.

4. The apparatus of claim 1, wherein the first connection control module is configured to receive a call request of the electronic device, and control the electronic device to establish a voice communication channel when receiving an answering instruction;
the first connection control module obtains the transmitted audio data transmitted of the electronic device through the wireless connection, comprising:
obtaining the transmitted audio data received from the voice communication channel of the electronic device through the wireless connection.

5. The apparatus of claim 4, comprising:
a voice collection module configured to collect the environmental voice;
the first connection control module is further configured to transmit the environmental voice to the electronic device through the wireless connection and trigger the electronic device to transmit the environmental voice to the voice communication channel.

6. The apparatus of claim 1, comprising:
a second connection control module configured to establish ZigBee connections with a plurality of detecting devices in the vehicles, and transmit the vehicle information detected by the plurality of detecting devices to the electronic device through the first connection control module.

7. The apparatus of claim 1, wherein the first connection control module is configured to:
establish connections with control devices disposed in a steering wheel;
obtain control commands of the control devices; and
transmit control commands to the electronic device and trigger the electronic device to respond to control commands.

8. An apparatus applied in a vehicular system, comprising:
a memory;
one or more program instruction modules, stored in the memory; and
one or more processors, couple to the memory to execute one or more program instruction modules to:
establish a wireless connection with an electronic device;
obtain an audio data of the electronic device through the wireless connection;
obtain a current reception band of a FM playback device in the vehicular system;
generate a first transmission command according to the current reception band;
respond to the first transmission command of the control module; and
transmit the audio data at the current reception band.

9. A vehicular system, comprising the processing apparatus and the FM playback device according to claim 1.

10. The vehicular system of claim 9, comprising:
control devices disposed in the steering wheel wireless connected to the processing apparatus; and
a plurality of detecting devices establishing the ZigBee connection with the processing apparatus;
wherein the processing apparatus is configured to obtain control commands transmitted by control devices, transmit control commands to the electronic device and trigger the electronic device to respond to control commands, obtain a vehicle information detected by the plurality of detecting devices, and transmit the vehicle information detected by the plurality of detecting devices to the electronic device through a first connection control module.

11. A method for processing the audio data applied in a vehicular system, comprising:
obtaining an audio data of the electronic device through the wireless connection after establishing a wireless connection with an electronic device;
obtaining a current reception band of a FM playback device in the vehicular system; generating a first transmission command according to the current reception band;
responding to the first transmission command of the control module, and
transmitting the audio data at the current reception band.

12. A method for processing the audio data applied in an electronic device, comprising:
establishing a wireless connection with a processing apparatus of the vehicular system;
transmitting an audio data to the process apparatus through the wireless connection;
obtaining a current reception band of a FM playback device in the vehicular system after the processing apparatus receives the audio data;
generating a first transmission command according to the current reception band;
responding to the first transmission command of the control module; and
transmitting the audio data at the current reception band.

13. A vehicular system, comprising the processing apparatus and the FM playback device according to claim 2.

14. A vehicular system, comprising the processing apparatus and the FM playback device according to claim 3.

15. A vehicular system, comprising the processing apparatus and the FM playback device according to claim 4.

16. A vehicular system, comprising the processing apparatus and the FM playback device according to claim 5.

17. A vehicular system, comprising the processing apparatus and the FM playback device according to claim 6.

18. A vehicular system, comprising the processing apparatus and the FM playback device according to claim 7.

19. A vehicular system, comprising the processing apparatus and the FM playback device according to claim 8.
